(19) United States
(12) Patent Application Publication
(10) Pub. No.: US 2010/0247479 A1
(43) Pub. Date: Sep. 30, 2010

(54) All natural oil spray

(76) Inventors: Linda F. Mackert, Cedar City, UT (US); Kenneth Collins K.C. Mackert, Cedar City, UT (US)

Correspondence Address: Linda F. Mackert, 93 N 4000 W, Cedar City, UT, 84720, US

(21) Appl. No.: 12/383,666

(22) Filed: Mar. 27, 2009

(51) Int. Cl. A01N 25/02; C10M 173/02

(52) U.S. Cl. 424/84; 508/216

(57) ABSTRACT

The “All Natural Oil Spray” makes cleaning litter boxes easier then before. It prevents most pet waste from sticking to litter boxes. It saves time, eliminating scraping & chiseling pet waste. No more cleaning, after torn plastic liner bags, due to pet claws, causing pet waste & litter to leak. It is affordable saving you money, no more buying liner bags. No more paying to replace litter boxes, due to scraping damage. It saves the cost of replacing broken scooper/sifter utensils. It helps limit physical discomfort in sifting litter or dumping it. This spray, when used with only the Vegetable oil, Eucalyptus oil & H2o is a “green product” made with all natural ingredients & recycled packaging. Making it safe for your pets. It also has a scent that attracts most pets to use the litter box. Best of all you'll use less plastic & help save your planet.

The present invention is an All Natural Oil Spray. It is made to use in any litter box/tray to create a non-stick inside surface on the bottom, sides, & corners. It can also be sprayed on the pet waste scooper/sifter utensils.

The main and first component is Vegetable Oil, which works as a type of non-stick lubricant. The second component is simply H2o, which makes the oils the right consistency to be used in a spray action, (In pump or can sprayer). The third component is Eucalyptus Oil, which simply adds a nice fragrance, and aids in attracting pets to use the litter box. The fourth component is a Propellant, and the fifth component is Soy Lecithin, and the sixth component is Dim Ethyl Silicone (for anti-foaming). These six previously mentioned components are to be used in (recycled) spray cans, in the future. Right now we are able to offer the first three-component combination; Vegetable Oil, H2o, and Eucalyptus Oil as the said all natural oil spray in recycled plastic spray bottle.

The mentioned invention; “All Natural Oil Spray” is a simple blend of; Vegetable Oil, H2o, and Eucalyptus Oil, shaken well (before using) and sprayed on the entire inside surface (bottom, sides, and corners) of any litter box. The product name for this invention (All Natural Oil Spray) will be; “Litter Box Slick Spray”. The “All Natural Oil Spray” will create a non-stick inside surface that will prevent most pet waste from sticking. The consumer should recoat the litter box at least once a month for one small pet and more often according to the number and/or size of pets. The “All Natural Oil Spray” can be made, and we may make it with any digestible oil instead of the vegetable oil we are now using. The “All Natural Oil Spray” made with any digestible oil can also be made with, and we may use a propellant of some kind to be used in a caned spray, instead of the plastic spray bottle. When in a can spray, we may use Soy Lecithin and also Dim Ethyl Silicone (for anti-foaming).

The mentioned invention; “All Natural Oil Spray” can be used as an aid in training pets to use the litter box and or tray. The Eucalyptus oil is a natural sent that causes most cats and some other small animals to urinate or expel waste on or in that scented area, of the Eucalyptus sent. The “All Natural Oil Spray” is safe to use in most pet waste litter boxes/ trays, and possibly cages, just in varying amounts according to the particular needs of each pet.

1. This invention is an all-natural oil spray, and comprises of, Vegetable Oil, H2O, & Eucalyptus oil.

2. This said invention of all natural oil spray, will save consumers with most litter boxes/trays, valuable time.

3. This said invention of all natural oils, will save the consumer money.

4. The composition of claim #1 further includes, that the mentioned oil spray creates a non-stick inside surface on the bottom, corners, and sides of most pet litter boxes/ trays.

5. The composition of claim #1 further includes, that the mentioned oil spray creates a non-stick surface on most pet waste scooping/sifting utensils.

6. The composition of claim #1 & #2 further includes, that the mentioned oil spray will aid greatly in turning a very unpleasant chore into a simple task, for most pet owners with litter boxes/trays.

7. The composition of claim #1 & #3 further includes, that the mentioned oil spray will reduce the need to purchase excessive plastics; plastic liners for litter boxes, replacing old litter boxes, (due to excessive clawing/scratching damage), & pet waste sifter/scooper utensils (broken from the force/effort needed to remove the stuck on pet waste)

8. The composition of claim #1 further includes, that the use of mentioned oil sprays ingredient Eucalyptus oil aids in attracting most pets to use the litter box or tray.

9. The composition of claim #1 further includes, that the mentioned oil spray is safe for most pets if used correctly.

10. The composition of claim #1 further includes, that the use of the mentioned oil spray will result in protecting our Earth from further plastic waste.

11. The composition of claim #1 further includes, that the use of mentioned oil spray instead of plastic liners, the consumer will eliminate the risk of their pet accidentally digesting small bits of plastic, after clawing and ripping the plastic liner & getting plastic stuck in their toes and then bathing and possibly choking or having digestive problems, caused by the plastic.

12. The composition of claim #2 further includes, that the mentioned oil spray is easy to apply to any pet litter boxes/tray in the form of a spray.
